(19) United States
(12) Patent Application Publication
(10) Pub. No.: US 2022/0000166 A1
(43) Pub. Date: Jan. 6, 2022

(54) METHODS OF BINDING FOOD PARTICLES WITH EDIBLE BEAN PRODUCTS AND PRODUCTS PRODUCED THEREFROM

(71) Applicant: Archer Daniels Midland Company, Decatur, IL (US)

(72) Inventors: Olivia Rhode, Mt. Zion, IL (US); Dena Strehlow, Maple Grove, MN (US)

(21) Appl. No.: 16/468,976

(22) PCT Filed: Dec. 12, 2017
(86) PCT No.: PCT/US17/65827

§ 371 Date: Jun. 12, 2019

Related U.S. Application Data
(60) Provisional application No. 62/432,821, filed on Dec. 12, 2016.

(51) Int. Cl. A23P 30/00; A23L 29/25; A23L 29/10; A23L 7/10; A23L 29/00

(52) U.S. Cl. CPC A23P 30/00; A23L 29/25; A23L 29/04; A23L 7/10; A23L 29/10

(57) ABSTRACT

Systems and apparatus for performing laser kerfing operations in boreholes. Systems and apparatus for providing a plurality of laser beams in a concentric ring laser beam pattern to create holes in the bottom of a borehole surface in a pattern correspond to the laser beam pattern. The system having mechanical devices to remove laser weakened rock that is associate with the laser created holes, the mechanical devices forming a removal pattern that is the negative of the concentric ring pattern.

### BACKGROUND OF THE INVENTION

The present inventions relate to high power laser energy tools, methods and systems.

As used herein, unless specified otherwise “high power laser energy” means a laser beam having at least about 1 kW (kilowatt) of power.

As used herein, unless specified otherwise, the term “earth” should be given its broadest possible meaning, and includes, the ground, all natural materials, such as rocks, and artificial materials, such as concrete, that are or may be found in the ground, including without limitation rock layer formations, such as, granite, basalt, sandstone, dolomite, sand, salt, limestone, rhyolite, quartzite and shale rock.

As used herein, unless specified otherwise, the term “borehole” should be given it broadest possible meaning and includes any opening that is created in a material, a work piece, a surface, the earth, a formation, a structure (e.g., building, protected military installation, nuclear plant, offshore platform, or ship), or in a structure in the ground, that is substantially longer than it is wide, such as a well, a well bore, a well hole, a micro hole, slimhole, a perforation and other terms commonly used or known in the arts to define these types of narrow long passages. Wells would further include exploratory, production, abandoned, reentered, reworked, and injection wells. Although boreholes are generally oriented substantially vertically, they may also be oriented on an angle from vertical, to and including horizontal. As used herein unless expressly provided otherwise, the “bottom” of a borehole, the “bottom surface” of the borehole and similar terms refer to the end of the borehole, i.e., that portion of the borehole furthest along the path of the borehole from the borehole's opening, the surface of the earth, or the borehole's beginning. The terms “side” and “wall” of a borehole should to be given their broadest possible meaning and include the longitudinal surfaces of the borehole, whether or not casing or a liner is present, as such, these terms would include the sides of an open borehole or the sides of the casing that has been positioned within a borehole. Boreholes may be formed in the sea floor, under bodies of water, on land, in ice formations, or in other locations and settings.

Boreholes are generally formed and advanced by using drilling equipment having a rotating drilling tool, e.g., a bit. For example and in general, when creating a borehole in the earth, a drilling bit is extending to and into the earth and rotated to create a hole in the earth. In general, to perform the drilling operation the bit must be forced against the material to be removed with a sufficient force to exceed the shear strength, compressive strength or combinations thereof, of that material.

As used herein, unless specified otherwise, the term “advancing” a borehole should be given its broadest possible meaning and includes increasing the length of the borehole. Thus, by advancing a borehole, provided the orientation is not horizontal, e.g., less than 90° the depth of the borehole may also be increased. The true vertical depth (“TVD”) of a borehole is the distance from the top or surface of the borehole to the depth at which the bottom of the borehole is located, measured along a straight vertical line. The measured depth (“MD”) of a borehole is the distance as measured along the actual path of the borehole from the top or surface to the bottom. As used herein unless specified otherwise the term depth of a borehole will refer to MD. In general, a point of reference may be used for the top of the borehole, such as the rotary table, drill floor, well head or initial opening or surface of the structure in which the borehole is placed.

As used herein, unless specified otherwise, the terms “ream”, “reaming”, a borehole, or similar such terms, should be given their broadest possible meaning and includes any activity performed on the sides of a borehole, such as, e.g., smoothing, increasing the diameter of the borehole, removing materials from the sides of the borehole, such as e.g., waxes or filter cakes, and under-reaming.

As used herein, unless specified otherwise, the terms “drill bit”, “bit”, “drilling bit” or similar such terms, should be given their broadest possible meaning and include all tools designed or intended to create a borehole.

In types of mechanical drilling the state of the art, and the teachings and direction of the art, provide that to advance a borehole great force should be used to push the bit against the bottom of the borehole as the bit is rotated. This force is referred to as weight-on-bit (“WOB”). Typically, tens of thousands of pounds WOB are used to advance a borehole using a mechanical drilling process. Mechanical bits cut rock by applying crushing (compressive) and/or shear stresses created by rotating a cutting surface against the rock and placing a large amount of WOB. For example, the WOB applied to an 8¾″ PDC bit may be up to 15,000 lbs, and the WOB applied to an 8¾″ roller cone bit may be up to 60,000 lbs. When mechanical bits are used for drilling hard and ultra-hard rock excessive WOB, rapid bit wear, and long tripping times result in an effective drilling rate that is essentially economically unviable. The effective drilling rate is based upon the total time necessary to complete the borehole and, for example, would include time spent tripping in and out of the borehole, as well as, the time for repairing or replacing damaged and worn bits.

As used herein, unless specified otherwise “offshore” and “offshore drilling activities” and similar such terms are used in their broadest sense and would include drilling activities on, or in, any body of water, whether fresh or salt water, whether manmade or naturally occurring, such as for example rivers, lakes, canals, inland seas, oceans, seas, bays and gulfs, such as the Gulf of Mexico. As used herein, unless specified otherwise the term “offshore drilling rig” is to be given its broadest possible meaning and would include fixed towers, tenders, platforms, barges, jack-ups, floating platforms, drill ships, dynamically positioned drill ships, semi-submersibles and dynamically positioned semi-submersibles. As used herein, unless specified otherwise the term “seafloor” is to be given its broadest possible meaning and would include any surface of the earth that lies under, or is at the bottom of, any body of water, whether fresh or salt water, whether manmade or naturally occurring. As used herein, unless specified otherwise the terms “well” and “borehole” are to be given their broadest possible meaning and include any hole that is bored or otherwise made into the earth's surface, e.g., the seafloor or sea bed, and would further include exploratory, production, abandoned, reentered, reworked, and injection wells.

Generally, the term “about” as used herein, unless specified otherwise, is meant to encompass a variance or range of ±10%, the experimental or instrument error associated with obtaining the stated value, and preferably the larger of these.

As used herein, unless specified otherwise, the terms “at least ______” or “greater than ______” means the same thing as “not having lower than ______” or “excluding lower than ______” or “not having less than ______” or “excluding less than ______.” Thus, the term “at least 10 kW” is the same as, and means the same thing as, the terms “not having a power lower than 10 kW” or “not having a power less than 10 kW”. Similarly, the term “greater than 10 kW” means the same thing as the terms “excluding a power lower than 10 kW′ or excluding a power less than 10 kW.”

This Background of the Invention section is intended to introduce various aspects of the art, which may be associated with embodiments of the present inventions. Thus, the forgoing discussion in this section provides a framework for better understanding the present inventions, and is not to be viewed as an admission of prior art.

### SUMMARY

It is desirable to develop systems and methods that provide for the delivery of high power laser energy to the bottom of a deep borehole to advance that borehole at a cost effective rate, and in particular, to be able to deliver such high power laser energy to drill through rock layer formations including granite, basalt, sandstone, dolomite, sand, salt, limestone, rhyolite, quartzite and shale rock at a cost effective rate. More particularly, it is desirable to develop systems and methods that provide for the ability to deliver such high power laser energy to drill through hard rock layer formations, such as granite and basalt, at a rate that is superior to prior conventional mechanical drilling operations. The present invention, among other things, solves these needs by providing the system, apparatus and methods taught herein.

There is provide a high power optical slip ring comprising: a base defining a cavity; an input fiber that is fixed and non-rotating with respect to the base; wherein the laser beam is launched from the input fiber into free space within the cavity, the input fiber in optical communication with a high power laser; a pair of lenses that are fixe and non-rotating with respect to the base and the input fiber; and, a output fiber that is rotatable with respect to input fiber; wherein the optical slip ring is configured to transmit a high power laser beam from a non-rotating optical fiber to a rotating output optical fiber.

There is further provided these apparatus, systems and method having one or more of the following features: wherein the input fiber has a core of about 200 μm; wherein the output fiber has a core of about 400 μm; wherein the output fiber has a core of about 200 to about 700 μm; wherein the output fiber has a core of about 400 μm; wherein the coupling efficiency is at least 95% or greater; wherein the coupling efficiency is at least 98% or greater; wherein the coupling efficiency is at least 99.5% or greater; wherein the coupling efficiency is at least 99.99% or greater; wherein the NA of the input fiber is from about 0.18 to about 0.22; wherein the NA of the input fiber is from about 0.18 to about 0.20; wherein the NA of the output fiber is from about 0.19 to about 0.24; wherein the NA of the output fiber is from about 0.21 to about 0.24; wherein the NA of the output fiber is from about 0.20 to about 0.24 and the NA of the input fiber is about 0.18 to 0.20; wherein the laser has a power of 60 kW or more; wherein the laser has a power of 40 kW to 80 Kw, and wherein the NA of the output fiber is from about 0.20 to about 0.24 and the NA of the input fiber is about 0.18 to 0.20; wherein the laser has a power of 40 kW to 80 Kw, wherein the NA of the output fiber is from about 0.20 to about 0.24 and the NA of the input fiber is about 0.18 to 0.20 and wherein the coupling efficiency is greater than 99.99%; wherein the laser has a power of 40 kW to 80 Kw, wherein the NA of the output fiber is from about 0.20 to about 0.24 and the NA of the input fiber is about 0.18 to 0.20 and wherein the coupling efficiency is 100%.

Still further there is provided a high power laser system for advancing a borehole, the system comprising: a means for generating a plurality of high power laser beams, the means comprising a plurality of solid state laser sources, each solid state laser source having a wavelength from about 400 nm to about 1,500 nm, the solid state laser sources selected from the group consisting of fiber lasers, semiconductor lasers and diode lasers, whereby the solid state laser sources are configured to deliver a plurality of laser beams, wherein each laser beam has a power of from about 2 kW to about 30 kW, with a total power of the plurality of beams being 60 kW or more; the plurality of solid state laser sources in optical communication with an optical slip ring, the optical slip ring comprising an input fiber in optical communication with the sold state laser sources, a pair of lenses that receive and re-focus the laser beam on a rotatable output fiber; the rotatable output fiber in optical communication with a laser kerfing bottom hole assembly; the laser kerfing bottom hole assembly, comprising a pressure window having a gas side and a flowing fluid side; the laser kerfing bottom hole assembly defining a laser beam pattern and mechanical removal pattern on the bottom surface of the borehole.

Furthermore, there are provided these systems, apparatus and methods having one or more of the following features: wherein the laser pattern and the mechanical cutter pattern do not overlap; wherein the laser pattern and the mechanical cutter pattern overlap; wherein the system is configured to generate from about 5 to about 100 laser beams; wherein the system is configured to generate from about 10 to about 20 laser beams; and wherein the coupling efficiency is greater than 99.9%.

Still additionally there is provided a method of transmitting a high power laser beam across a rotating junction, the method comprising: transmitting a high power laser beam, having a power of at least 40 kW through an input fiber having an input connector, the input fiber in optical communication with an optical slip ring; launching the laser beam from input connector to a pair of lenses; the lenses directing and focusing the laser beam on a rotating output connector having a rotating output fiber; and, the laser beam entering the rotating core of the output fiber with 100% coupling efficiency.

There is provided a high power laser kerfing system for advancing a borehole, the system comprising: a means for generating a plurality of high power laser beams, the means comprising a plurality of solid state laser sources, each solid state laser source having a wavelength from about 400 nm to about 1,500 nm, the solid state laser sources selected from the group consisting of fiber lasers, semiconductor lasers and diode lasers, whereby the solid state laser sources are configured to deliver a plurality of laser beams, wherein each laser beam has a power of from about 2 kW to about 30 kW; the plurality of solid state laser sources in optical communication with a laser kerfing bottom hole assembly, comprising a pressure window having a gas side and a flowing fluid side; the laser kerfing bottom hole assembly defining a laser beam pattern and mechanical removal pattern on the bottom surface of the borehole.

There is further provide these systems, apparatus and methods having one or more of the following features: wherein the laser pattern and the mechanical cutter pattern do not overlap; wherein the laser pattern and the mechanical cutter pattern overlap; wherein the system is configured to generate from about 5 to about 100 laser beams; wherein the system is configured to generate from about 10 to about 20 laser beams; wherein the wave length is less than 750 nm, and a majority of the laser beams have a cross section of less than 2.5 mm, and a spacing between the beams that is greater than or equal to 2.5 mm; comprising an optical fiber optical communication with at least one of the laser sources and having a length of at least 1 km.

Moreover, there is provided a method of laser drilling using a laser kerfing assembly, the method comprising delivering a plurality of laser beams, each having a power of at least about 1 kW, to a window in optical and mechanical communication with a laser-fluid channel; transmitting the laser beams through the window and into a flowing fluid in the laser fluid-channel; the laser fluid channel in mechanical association with a plurality of cutters fixed with respect to the laser-fluid channel and a position of the laser beams in the laser-fluid channel; engaging the cutters with the bottom of a borehole surface; delivering the laser beams and fluid to the surface of the borehole, while rotating the laser-fluid channel and cutters, wherein the laser beam removes a first section of the borehole surface and the cutters remove a second section of the borehole surface; whereby the borehole is advanced.

Yet additionally there are provided these systems, methods and apparatus having one or more of the following features: wherein the laser beam does not directly strike the second section of borehole surface; wherein the laser beam only weakens the second section of borehole surface; comprising 5 to 50 laser beams; wherein each laser beam has a diameter of from about 0.5 mm to about 4.5 mm; wherein the laser beams are parallel; wherein the majority by weight of the fluid is water; wherein the wavelength is from about 450 nm to about 750 nm; wherein the wavelength is from about 700 nm to about 1,250 nm; wherein the wave length is less than 750 nm; wherein a majority of the laser beams have a cross section of less than 2.5 mm, and a spacing between the beams that is greater than or equal to 2.5 mm; and transmitting the high power laser beams over an optical fiber in a conveyance cable for a distance of greater than 1 km, greater than 2 km, and greater than 5 km.

Still additionally there is provided a method of laser kerfing drilling, comprising delivering a laser beam pattern to the surface of a borehole, the laser beam pattern comprising a plurality of concentric rings; removing material from the surface of the bottom of the borehole in a pattern corresponding to the laser beam delivery pattern; providing a mechanical force pattern to the surface of the borehole; the mechanical force removing material from the borehole surface; whereby the borehole is advanced.

Moreover there is provide a method of high power laser drilling by creating leading laser kerfs and following mechanical removal of non-laser affected material, the method comprising: generating a plurality of high power laser beams from a plurality of solid state laser sources, each solid state laser source having a wavelength from about 400 nm to about 1,500 nm, the solid state laser sources selected from the group consisting of fiber lasers, semiconductor lasers and diode lasers, whereby the solid state laser sources are configured to deliver a plurality of laser beams, wherein each laser beam has a power of from about 2 kW to about 30 kW; transmitting the plurality of laser beams to a laser kerfing assembly; the laser kerfing assembly comprising a sealed chamber, having a window; a fluid flow path exterior to the sealed chamber; a window from a part of the sealed chamber and a part of the fluid flow path; a bit section having a plurality of cutters and a laser beam channel; directing the plurality of laser beams through the window and the laser beam channel onto a surface of a borehole in a laser beam pattern; directing a liquid through the fluid flow path, into the laser beam channel, and onto the surface of the borehole; and, engaging the laser kerfing assembly with the bottom surface of a borehole and rotating the laser kerfing assembly; whereby the laser beam and mechanical cutters independently remove material from the borehole surface.

There is provide a high power laser system having a high power laser for providing a high power laser beam having a wavelength, the laser in optical communication with a bottom hole assembly for providing a laser beam pattern to a surface of a borehole in a formation in the earth, wherein the improvement includes: a laser kerfing assembly, wherein the laser kerfing assembly is a part of the bottom hole assembly; the laser kerfing assembly including: an outer housing, the outer housing capable of withstanding borehole pressures and conditions at 3,000 m vertical depth; a sealed channel defining a cavity comprising a plurality of laser beam paths; the sealed channel having a proximal end and a distal end; the distal end comprising a pressure window transmissive to the laser beam wavelength; the pressure window having a proximal side and a distal side; a fluid channel, the fluid channel positioned exterior to the sealed channel and within the outer housing, the fluid channel defining a fluid flow path; the proximal side of the pressure window facing the cavity and the distal side facing the fluid channel; a bit having a laser beam channel and a plurality of cutters positioned on a distal face of the bit, whereby the cutters are capable of engaging with the bottom surface of the borehole; the laser beam channel in fluid communication with the fluid channel and defining a part of the fluid path; and, wherein the laser beam paths extends from the proximal end of the cavity through the cavity to the proximal face of the pressure window through the pressure window into the fluid channel and into the laser beam channel; whereby the laser beam path leaves the distal face of the bit; wherein the system is configured to provide 5 to 100 laser beams along 5 to 100 laser beam paths, and configured for each laser beam to have a cross section of about 0.9 mm to about 3 mm.

There is further provided these apparatus, systems and methods having one or more of the following features: wherein the laser is from about 40 kW to about 80 kW; wherein the laser beam paths are parallel; wherein all laser beams have the same cross section; wherein the laser beam paths are spaced apart by a distance that is smaller than the beam cross section; wherein the laser beam paths are spaced apart by a distance that is larger than the beam cross section; wherein two of laser beam paths are spaced apart by a distance that is the same as the beam cross section; wherein there are from 5 to 40 laser beam paths, and the bit defines a diameter that about 95 mm to about 330, and the pressure window has a diameter of at least 85% of a dimeter of the bit; wherein the system is configured for a laser beam to have a power of at least about 2 kW; wherein the system is configured for a laser beam to have a power from about 2 kW to about 15 kW; and, wherein the system is configured for each laser beam to have a power from about 2 kW to about 15 kW.

There is also provided these systems, apparatus and methods having one or more of the following features: wherein the assembly is configured to withstanding borehole pressures and conditions: at 2,000 m vertical depth, and greater; at 3,000 m vertical depth, at greater; at 4,000 m vertical depth, greater; at 5,000 m vertical depth, and greater; and at 7,000 m vertical depth and greater.

A kerfing laser bit including: a pressure window having a first surface and a second surface, and having a plurality of laser beam paths extending through the pressure window from the first surface to the second surface; the window having a gas contacting the first surface and a flowing liquid contacting the second surface; the laser beam paths spaced apart from each other and configured so as to not overlap in the window; the bit having a cutting face for contacting the bottom surface of a borehole; the cutting face having a plurality of spaced apart cutters; whereby upon rotation of the bit, the laser beam paths form an annular pattern of concentric laser pattern rings, and whereby upon rotation the cutters form an annular pattern of concentric cutter pattern rings.

Still further, there is provided these systems, apparatus and methods having one or more of the following features: wherein the concentric laser pattern rings partially overlap the concentric cutter pattern rings; wherein the concentric laser pattern rings do not overlap the concentric cutter pattern rings; and wherein the laser beam paths are parallel.

Moreover there is provided a high power laser system having a high power laser in optical communication with a down hole laser tool for providing a laser beam pattern to a surface of a borehole in a formation in the earth, wherein the improvement is: the down hole laser tool for delivering a laser beam pattern to the surface of the borehole, wherein the surface of the borehole is formed by the formation; the laser beam pattern having a plurality of laser beam shots; wherein upon delivery of the laser beam in the laser beam pattern to the surface of the borehole, the laser beam removes material from the formation in a removal pattern that matches the laser beam pattern, thereby leaving a remaining material pattern of remaining formation material that is a negative of the laser beam pattern; and, a mechanical device capable of removing the remaining formation material in the remaining material pattern.

Moreover, there is provide these systems, methods and apparatus having one or more of the following features: wherein the laser beam pattern is a plurality of linear shots; wherein the laser beam pattern defines a grid pattern of intersecting linear laser beam shots; wherein the laser beam pattern is a plurality of spaced apart shots; wherein the shots have a cross section of from about 0.5 mm to about 3 mm; wherein the majority of the shots in the laser beam pattern are circular and have a diameter of about 0.9 mm to about 3.0 mm; wherein the majority of the shots in the laser beam pattern have a shot spacing of about 5 mm to about 40 mm; wherein the majority of the shots in the laser beam pattern have a shot spacing of about 8 mm to about 25 mm; wherein the shot pattern fills the bottom surface of a borehole and is adjacent a side wall of the borehole; wherein an outer diameter of the laser beam shot pattern is from about 100 mm to about 250 mm; wherein an outer diameter of the laser beam shot pattern is from about 140 mm to about 180 mm; wherein an outer diameter of the laser beam shot pattern is from about 180 mm to about 250 mm; wherein the laser shots fill about 10% to about 50% of the area of the laser beam pattern; wherein the laser shots fill less than about 30% of the area of the laser beam pattern; wherein the laser shots fill less than about 10% of the area of the laser beam pattern; and, wherein the laser shots fill less than about 2% of the area of the laser beam pattern.

Yet additionally, there is provided these systems, methods and apparatus having one or more of the following features: wherein upon delivery of the laser beam in the laser beam pattern to the surface of the borehole, the laser beam removes initial formation material from the formation in a removal pattern that matches the laser beam pattern, leaving a remaining material pattern of remaining formation material that is a negative of the laser beam pattern and that is about 50% or more of the initial formation material; having a mechanical device capable of removing the remaining formation material in the remaining material pattern; wherein the laser shot pattern is stationary and does not rotate; wherein an the area of the laser beam shot pattern is from about 30 mm² to about 320 mm²; wherein the total laser shot area is less than about 10% of the laser pattern area and whereby the remaining formation material is about 90% or more of the initial formation material; wherein the total laser shot area is less than about 5% of the laser pattern area and whereby the remaining formation material is about 95% or more of the initial formation material; wherein the total laser shot area is less than about 2% of the laser pattern area and whereby the remaining formation material is about 98% or more of the initial formation material; wherein the total laser shot area is less than about 1% of the laser pattern area and whereby the remaining formation material is about 99% or more of the initial formation material; and wherein the laser beam pattern comprise gauge cutting laser beam shots.

### BRIEF DESCRIPTION OF THE DRAWINGS

FIG. 1 is a schematic of an embodiment of an optical slip ring assembly in in accordance with the present inventions.

FIG. 2 is a cross sectional view of an embodiment of a laser kerfing bit in accordance with the present inventions.

FIG. 3 is a schematic view of an embodiment of a laser kerfing bottom hole assembly in accordance with the present inventions.

FIG. 4. is a schematic cross sectional perspective view of an embodiment of a deployed laser kerfing drilling system in accordance with the present inventions.

### DESCRIPTION OF THE DRAWINGS AND THE PREFERRED EMBODIMENTS

In general, embodiments of the present inventions relate to, methods, apparatus and systems for use in laser drilling of a borehole in the earth, and further, relate to equipment, methods and systems for the laser advancing of such boreholes deep into the earth and at highly efficient advancement rates.

In general, the present inventions relate to methods, apparatus and systems for use in laser drilling of a borehole in the earth, and further, relate to equipment, methods and systems for the laser advancing of such boreholes deep into the earth and at highly efficient advancement rates. These highly efficient advancement rates are obtainable because the present kerfing mechanical drilling methods.

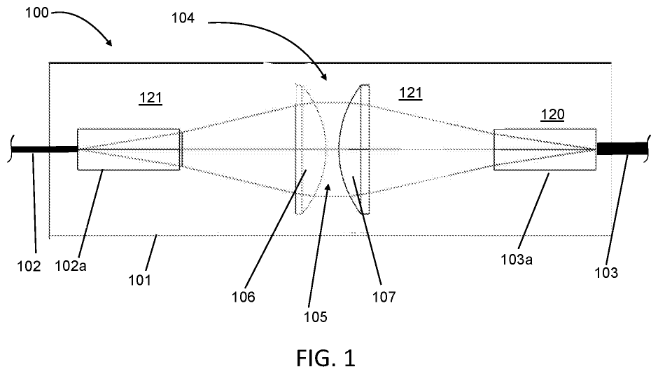

In particular, the present inventions relate to high power optical slip rings that are used in laser drilling systems, for example in laser kerfing drilling systems and methods. Turning to FIG. 1, there is shown an embodiment of a high power optical slip ring (OSR) 100. The OSR 100 has an outer housing 101, that contains bearing supports, bearings, cooling lines and elements electronics, etc. The housing preferably also contains slip rings, rotating transitions for fluid conveyance and for electronics and electrical conveyance. The OSR forms an optical communication, e.g., transitions, for a laser beam from a non-rotating fiber to a rotating fiber. The OSR 100 has an input fiber 102 that has a connector 102a, from which the laser beam is launched. The laser beam ray trace and shape and path of the laser beam is shown by ray lines 104. Optical fiber 102 is connected to a high power laser(s). The laser beam exits connector 102a expands and travels to a pair of lens 106, 107. The space 105 between those two lenses, is preferably collimated space. Lens 107 then focusses the laser beam down to a small spot that is launched into fiber 103, which has a connector 103a. Optical connector 103a and output fiber 103 are rotating, or capable of rotation, around the axis of the connector 103a and in relation to the housing 101. Lenses 107, 106, connector 102a and fiber 102 do not rotate, and are fixed with respect to housing 101. Thus, and generally section 120 of the OSR 100 rotates, or is rotatable, while section 121 does not rotate and is fixed.

The ability to launch directly into a rotating connect and fiber provides many advantages to the present system. It reduces the detrimental effect vibrations and other environment conditions can have on the system, among other things. The input fiber 102 is preferably a 200 μm core fiber having an NA from 0.18 to 0.22, and the rotating output fiber 103 is preferably a 400 μm core fiber having an NA from about 0.2 to 0.24. The coupling efficiency across the rotating transition, i.e., non-rotating components 102, 101a, 106, 107 to rotating components 103a, 103 is about 100% and preferably from input fibers smaller than 0.21 μm is 100%.

The input fiber 102 can transit and the output (rotating) fiber 103 can receive 40 kW or more power, 50 kW or more power, 60 kW or more power, and 70 kW or more power, as well as, greater and lesser powers and powers within this range.

The input fiber can have a core of about 200 μm, as well as larger and smaller cores, and the output, i.e., rotating fiber can have a core of about 400 μm, about 500 μm about 600 μm and about 700 μm. It is preferable for the output fiber core to be as small as possible and still update a high, e.g., 95% or greater, coupling efficiency and more preferably to obtain a 100% coupling efficiency. In a preferred embodiment the core of the output fiber is about 2× to 3× larger than the core of the input fiber, with 100% coupling efficiency.

Safety interlocks are located preferably on the output couple, preventing the laser from firing unless the output coupler is properly connected to the unit.

In laser kerfing mechanical drilling of a borehole into and through the earth, e.g., a formation in the earth, several small laser beams can be used to form small holes, channels and ring cuts, in the formation forming the bottom or sidewall of the borehole in a pattern. The small holes can be spaced apart from each other in a predetermined pattern. The spots are rotated about a central axis of the bottom hole assembly, which typically is coaxial with the axis of the borehole. The laser shots are rotated about the tool, borehole, axis resulting in a series of concentric ring like cuts in the bottom surface of the borehole. The laser beam that creates the small discrete arcuate holes or channels or cuts (if pulsed), or circular rings or channels or cuts (if continuous) in the formation has the effect of damaging or wreaking the surround rock (e.g., earth, formation). Thus, even though the laser beam does not directly strike the rock, it has the affect of damaging or weakening it in the area surround the small laser created holes. The laser affected material (e.g., rock, formation, earth) can them be removed by mechanical means, hydraulic means, and combinations and variation of these. These removal means can be for example a hammer bit, a cutter, a scrapper, a drill bit, a rotary bit, a fluid jet, a particle jet, and other known and later developed devices for cutting or removing earth. Substantially, less force is required to remove the laser affected material that would be needed to remove this material prior to being damaged by the laser. The force can be 10%, 20%, 50% and 60% less to remove the laser affected material than to remove the unaffected (prior to laser damage) material.

The laser beams forming the shots in the laser beam pattern can be the same or different wavelengths. The laser beams can have beam diameters, at the point where they form the laser spot on the surface of the bottom of the borehole that are from about 0.2 mm to about 40 mm in cross section, the cross sections can be from about 0.5 mm to about 2.5 mm, from about 1 mm to about 5 mm, about 1 mm, about 2 mm and about 2.5 mm.

The spots, (e.g., laser spots, shots, or spots formed by laser beam shots) that form the laser beam pattern can be circular, arcuate, elliptical, linear, square, rectangular or other shapes. The spots can be over lapping, partially overlapping, or separated by predetermined distances and spacing. The spots can be staggered or in line.

The laser beam spots each have their own area, the sum of these area provides a total area of the surface of the borehole that is directly contacted by the laser. This area of direct laser contact is substantially smaller than the total area of the surface of the borehole. The area of direct laser contact, e.g., the total laser spot area, can be 50% or more smaller, 60% or more smaller, 80% or more smaller, 90% or more smaller, 95% or more smaller, than the area of the bottom surface of the borehole, or a cross sectional area of the borehole based upon the borehole diameter.

The laser spots are configured to form a laser beam pattern. In embodiments, the laser beam pattern is the same size, the outer ends of the pattern, are about same diameter and shape of the borehole and borehole diameter. In this manner, the total spot area can be 50% or more smaller, 60% or more smaller, 80% or more smaller, 90% or more smaller, 95% or more smaller, 99% or more smaller than the area of the laser pattern.

The laser beam spots can have the same or different powers, and can have the same or different wavelengths. The power of the individual spots in a pattern can be 1 kW or greater, 2 kW or greater, 5 kW or greater, 15 kW or greater, 20 kW or greater, from about 2 kW to about 15 kW, from about 1 kW to about 10 kW, as well as greater and lower powers and powers within these ranges.

An embodiment of the laser kerfing bottom hole assembly, and a laser kerfing drilling system, in general, is shown by the schematic of FIG. 3. This assembly can have a bit section 705, that has channel 706 where the laser beams and fluid exit toward the borehole surface. A chamber section 704, which has a sealed laser channel, and a window that provides the transition of the optical path from the channel section 704 to the bit section 705. A motor section 703, a connection section 702 and a cable 701. There can also be located in one or more of the sections, controllers, laser optics, optical assemblies (for e.g., shaping, directing and both, the laser beams), fluid flow channels, (e.g., for cooling components of the assembly, for directing a cutting fluid, such as a water based fluid and both), and control and monitoring equipment, among other things.

Turning to FIG. 1, there is shown a perspective view of a laser kerfing assembly 100 that is part of a laser bottom hole assembly. The laser kerfing assembly 100 has a body 104 that has a bit (or bit plate) 102 and a housing 105. The housing 105 has a distal end that is connected to the proximal end of the bit 102. The bit 102 has a face 107 that engages the bottom surface of the borehole. The bit 102 has cutters (such as PDC cutters), e.g., 103a, 103b, 103c. The bit 102 has a channel (or laser beam channel) 107 through which the laser beam paths and laser beams travel, as well as, the fluid, e.g., an aqueous fluid, forming a jet, e.g., a water jet.

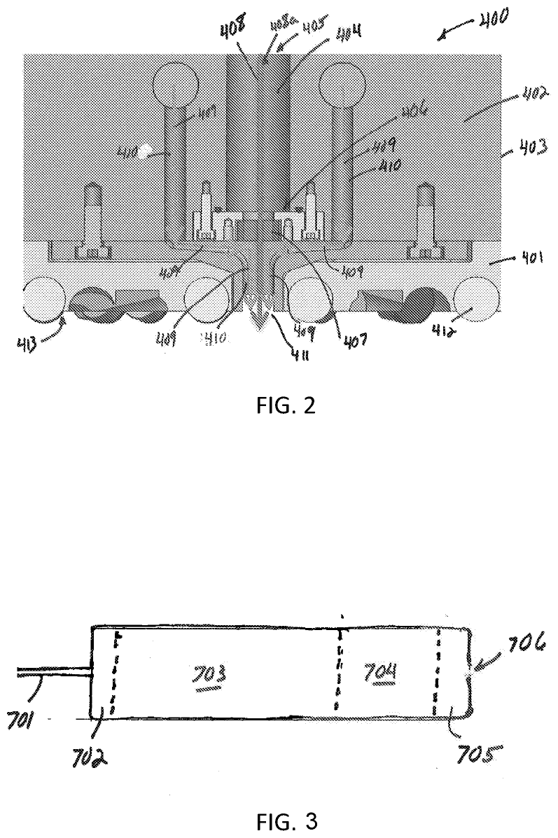

Turning to FIG. 2, there is shown a cross sectional view of a kerfing laser mechanical assembly 400 that can be used with a down hole tool, for example a BHA. The kerfing assembly 400 has a housing 402 and a housing wall 403, and a bit 401. The housing contains a chamber 404, that in preferred embodiments is a sealed channel containing a gas, which can be pressurized. The chamber 404 is sealed and formed in part by window 407. The chamber 404 has a proximal end 405 and a distal end 406. The proximal end 405 receives the laser beam 408a, traveling along laser beam path 408. The laser beam 408a traveling along beam path 408 travels through the chamber 404 (and the gas contained in the chamber) into the window 407, where it is transmitted through the window 407, and exits the window 407 into laser beam channel 411 and exits the laser beam channel 411 to form a spot on the borehole surface. and exit the window. While a single laser beam path 408 and laser beam 408a are shown, there are several additional beams and beam paths not shown as this is a cross sectional view. Within the housing 402 and between wall 403 and chamber 404 there is a fluid channel 410. The fluid channel 410 joins with laser channel 411 in the bit 401 at the distal face of the window 407. In this manner, the laser beam paths and laser beams exit the distal face of the window and enter into the fluid-laser channel, where the travel through the bit and exit the distal face of the bit as a series of individual laser beams in an elongate fluid jet.

To avoid, reduce or minimize the absorption of the laser energy by the fluid, e.g., absorbance by water for certain wavelengths, the distance from the window to the surface of the borehole can keep to a minimum. Thus, this distance, which is the distance of the laser channel plus the height of the cutters 402, can be less than about 150 mm, less than about 100 mm, less than about 50 mm, less than about 25 mm, can be from about 25 mm to about 100 mm, about 25 mm to about 75 mm, about 75 mm to about 200 mm, greater and shorter distance and all distances within these ranges. Similarly, the length of the laser channel can be less than about 150 mm, less than about 100 mm, less than about 50 mm, less than about 25 mm, can be from about 25 mm to about 100 mm, about 25 mm to about 75 mm, about 75 mm to about 200 mm, greater and shorter distance and all distances within these ranges.

The fluid channel 410 provides for a fluid flow path 409. The fluid flow path 409 and the laser beam path 408 are brought together when the fluid channel 410, joins and forms a part of the laser channel 411.

In operation, the kerfing assembly 401 is rotated and the laser beams form spots on the borehole surface. The spots are rotated about the borehole surface cutting channels, which are ring shaped channel in that surface. Thus, there is provide a laser beam pattern of concentric rings, which when delivered to the surface of the borehole removes the formation at the bottom of the borehole in concentric ring like channels. The laser cutters, e.g., 412 which are located on the distal face 413 of the bit 401 are also rotated and based upon cutter placement from a mechanical removal pattern and when rotated against the bottom surface of the borehole remove the formation in a pattern corresponding to the mechanical removal pattern.

The mechanical removal pattern can overlap, partially overlap, or not overlap with the laser beam pattern. In the situation where there is no overlap with the laser beam pattern, the cutters would not contact any rock that was directly contacted by the laser beam.

In an embodiment the laser beam pattern is a line of shots that form circular spots on the bottom surface of the borehole. The laser shots and circular spots have a diameter from about 0.4 mm to about 4.5 mm, about 0.9 mm to about 2.5 mm and about 1.5 mm to about 2 mm. During drilling the laser beam pattern is rotated around the bottom surface of the borehole. In this manner the laser beam creates a series of arcuate holes that form a removal pattern of concentric rings, leaving a pattern of remaining borehole surface and the formation material that forms the borehole bottom surface, which remaining material is in between and adjacent the rings and forms a pattern that is a negative of the laser beam delivery pattern. If the laser beams are pulsed the rings will be a series of disconnected arcuate rings. If the laser beams are continuous the rings will be circular holes. Combinations of pulsed and continuous are contemplated, thus for example a continuous circular hole can be located at or closest to the borehole sidewall, and the disconnected arcuate rings are located inside of the outer circular ring. The spacing between the rings can be uniform, it can be staggered; and it can be staggered so that the shot paths, (e.g., the circular holes) do not coincide with a cutter path. In this manner the bottom surface of the borehole has two discrete areas, one area that is directly contacted by the laser beam, the “laser removal area”; and another that is directly contacted by the mechanical removal device (e.g., cutters, water jets, etc.), the “mechanical removal area”. In preferred embodiment the laser beam does not directly contact the mechanical removal area; and the cutters do not directly contact the laser removal area.

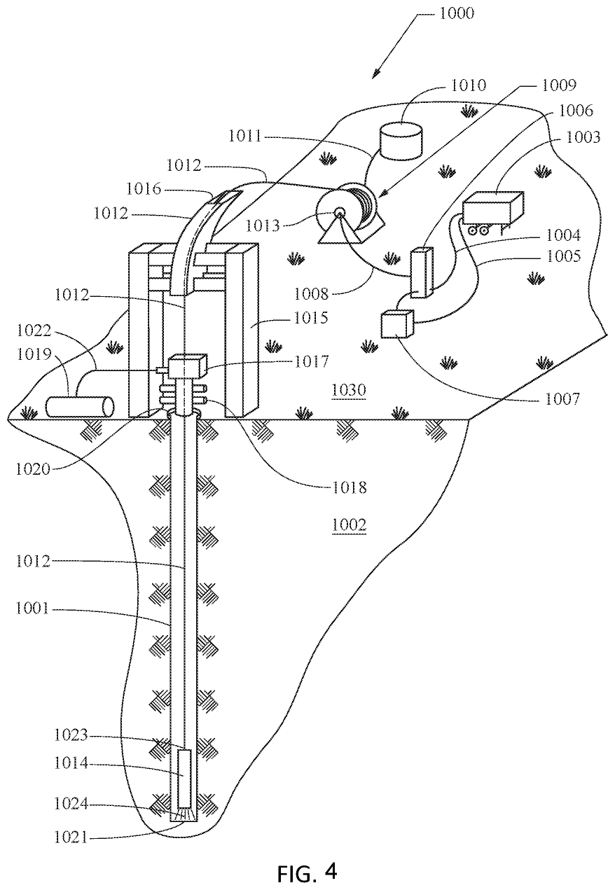

Thus, in general, and by way of example, there is provided in FIG. 4 a high efficiency laser kerfing drilling system 1000 for creating a borehole 1001 in the earth 1002. As used herein the term “earth” should be given its broadest possible meaning, including without limitation rock layer formations, such as, granite, basalt, sandstone, dolomite, sand, salt, limestone, rhyolite, quartzite and shale rock.

FIG. 4 provides a cut away perspective view showing the surface of the earth 1030 and a cut away of the earth below the surface 1002. In general and by way of example, there is provided a source of electrical power 1003, which provides electrical power by cables 1004 and 1005 to a laser 1006 and a chiller 1007 for the laser 1006. The laser provides a laser beam, i.e., laser energy, that can be conveyed by a laser beam transmission means 1008 to a spool of coiled tubing 1009. A source of fluid 1010 is provided. The fluid is conveyed by fluid conveyance means 1011 to the spool of coiled tubing 1009.

The spool of coiled tubing 1009 is rotated to advance and retract the coiled tubing 1012. Thus, the laser beam transmission means 1008 and the fluid conveyance means 1011 are attached to the spool of coiled tubing 1009 by means of rotating coupling means 1013, which is the optical slip ring of the embodiment of FIG. 1. The coiled tubing 1012 contains a means to transmit the laser beam along the entire length of the coiled tubing, i.e., “long distance high power laser beam transmission means,” to the laser kerfing bottom hole assembly, 1014. The coiled tubing 1012 also contains a means to convey the fluid along the entire length of the coiled tubing 1012 to the laser kerfing bottom hole assembly 1014.

Additionally, there is provided a support structure 1015, which holds an injector 1016, to facilitate movement of the coiled tubing 1012 in the borehole 1001. Further other support structures may be employed for example such structures could be derrick, crane, mast, tripod, or other similar type of structure or hybrid and combinations of these. As the borehole is advance to greater depths from the surface 1030, the use of a diverter 1017, a blow out preventer (BOP) 1018, and a fluid and/or cutting handling system 1019 may become necessary. The coiled tubing 1012 is passed from the injector 1016 through the diverter 1017, the BOP 1018, a wellhead 1020 and into the borehole 1001.

The fluid, which can be water, brine, drilling mud, or gas, is conveyed to the bottom 1021 of the borehole 1001. At that point the fluid exits at or near the laser kerfing bottom hole assembly 1014 and is used, among other things, to carry the cuttings, which are created from advancing a borehole, back up and out of the borehole. Thus, the diverter 1017 directs the fluid as it returns carrying the cuttings to the fluid and/or cuttings handling system 1019 through connector 1022. This handling system 1019 is intended to prevent waste products from escaping into the environment and separates and cleans waste products and either vents the cleaned fluid to the air, if permissible environmentally and economically, as would be the case if the fluid was nitrogen, or returns the cleaned fluid to the source of fluid 1010, or otherwise contains the used fluid for later treatment and/or disposal.

The BOP 1018 serves to provide multiple levels of emergency shut off and/or containment of the borehole should a high-pressure event occur in the borehole, such as a potential blow-out of the well. The BOP is affixed to the wellhead 1020. The wellhead in turn may be attached to casing. For the purposes of simplification the structural components of a borehole such as casing, hangers, and cement are not shown. It is understood that these components may be used and will vary based upon the depth, type, and geology of the borehole, as well as, other factors.

The downhole end 1023 of the coiled tubing 1012 is connected to the laser kerfing bottom hole assembly 1014. The laser kerfing bottom hole assembly 1014 contains optics for delivering the laser beam 1024 in a laser beam pattern having a plurality of laser beam shots to its intended target, in the case of FIG. 1, the bottom 1021 of the borehole 1001. The laser kerfing bottom hole assembly 1014, for example, also contains means for delivering the fluid.

Thus, in general this system operates to create and/or advance a borehole by having the laser create laser energy in the form of a laser beam. The laser beam is then transmitted from the laser through the spool and into the coiled tubing. At which point, the laser beam is then transmitted to the bottom hole assembly where it is directed toward the surfaces of the earth and/or borehole as a plurality from about 10 to 50 to 100 to more, of individual laser shots that form a laser beam delivery pattern on, e.g., the bottom of the surface of the borehole. Upon contacting the surface of the earth and/or borehole the laser beam spots have sufficient power (from about 2 kW to about 20 kW or more) to cut, or otherwise effect, the rock and earth creating areas of laser removed material, that mirrors the laser beam pattern and an area of the earth that remains in a pattern that is the mirror image of the laser beam pattern, the remaining material is also weekend by the thermal and other effects of the laser beam spots.

The remaining material can them be removed by a mechanical device, requiring significantly less force then would be needed to remove unaffected material, i.e., the material before it was weakened by the laser. In a preferred embodiment the laser weakened material, the formation or the earth, is not directly contacted with the laser beam. Thus, in embodiments the remaining formation material has not been struck, and preferably not struck directly by the laser beam or the laser beam pattern. The weakened material is then mechanically removed by for example a cutter, hammer, bit, a probe, or drill bit. Fluid jets, and particle jets, may also be used in conjunction with mechanical cutting devices. The laser beam at the point of contact has sufficient power and is directed to the rock and earth in such a manner that it is capable of borehole creation that is comparable to or superior to a conventional mechanical drilling operation. Depending upon the type of earth and rock and the properties of the laser beam this cutting occurs through spalling, thermal dissociation, melting, vaporization and combinations of these phenomena.

The fluid then carries the cuttings up and out of the borehole. As the borehole is advanced the coiled tubing is unspooled and lowered further into the borehole. In this way the appropriate distance between the bottom hole assembly and the bottom of the borehole can be maintained. If the bottom hole assembly needs to be removed from the borehole, for example to case the well, the spool is wound up, resulting in the coiled tubing being pulled from the borehole. Additionally, the laser beam may be directed by the bottom hole assembly or other laser directing tool that is placed down the borehole to perform operations such as perforating, controlled perforating, cutting of casing, and removal of plugs. This system may be mounted on readily mobile trailers or trucks, because its size and weight are substantially less than conventional mechanical rigs.

In addition to coiled tubing drill strings may be used, a wire line and down hole tractor may be used, as well as other conveyance systems known in the art.

In an embodiment, the lasers are located down hole, at or near, or as a part of the laser bottom hole assembly. In this manner the laser beam(s) that from the laser beam spots can be generated down hole. Down hole lasers and laser beam generation is taught and disclosed in US Patent Publication No. 2016/0084008, the entire disclosure of which is incorporated herein by reference.

Embodiments of laser drilling systems, laser down hole assemblies, optical assemblies and other laser drilling systems are components are disclosed and taught in U.S. Pat. Nos. 8,511,401, 8,826,973, 9,244,235, 9,074,422, 8,571,368, 9,027,668, and 8,661,160, the entire disclosures of each of which are incorporated herein by reference.

The laser can generate laser beams from about greater than about 1 kW, greater than about 5 kW, greater than about 20 kW, greater than about 40 kW, from about 20 kW to about 40 kW, from about 1 kW to about 80 kW or more. The laser beams that from each laser beam spot can be from about 1 kW, about 2 kW, about 5 kW, about 10 kW, about 15 kW, about 20 kW, from about 1 kW to about 20 kW, and greater.

The laser beam can have a wavelength from about 400 nm to about 1,550 nm, about 400 nm to about 600 nm, less than about 800 nm, from about 450 nm to about 900 nm, about 400 to about 500 nm, about 500 nm to about 600 nm, about 600 nm to about 700 nm, and about 900 nm to about 1,200 nm, high and lower wavelengths may also be used.

The present systems, may include one or more optical manipulators. An optical manipulator may generally control a laser beam, such as by directing or positioning the laser beam to spall material, such as rock. In some configurations, an optical manipulator may strategically guide a laser beam to spall material, such as rock. For example, spatial distance from a borehole wall or rock may be controlled, as well as the impact angle. In some configurations, one or more steerable optical manipulators may control the direction and spatial width of the one or more laser beams by one or more reflective mirrors or crystal reflectors. In other configurations, the optical manipulator can be steered by an electro-optic switch, electroactive polymers, galvonometers, piezoelectrics, and/or rotary/linear motors. In at least one configuration, a diode laser or fiber laser optical head may generally rotate about a vertical axis to increase aperture contact length. Various programmable values such as specific energy, specific power, pulse rate, duration and the like maybe implemented as a function of time. Thus, where to apply energy may be strategically determined, programmed and executed so as to enhance a rate of penetration and/or laser/rock interaction, to enhance the overall efficiency of borehole advancement, and to enhance the overall efficiency of borehole completion, including reducing the number of steps on the critical path for borehole completion. One or more algorithms may be used to control the optical manipulator.

In general, embodiments of the down hole assembly, laser bottom hole assembly (LBHA) or bottom hole assembly (BHA) which terms are to be used interchangeable, unless specifically provided otherwise, may contain an outer housing that is capable of withstanding the conditions of a downhole environment and optics for the shaping and directing a laser beam on the desired surfaces of the borehole, casing, or formation. The assembly may further contain or be associated with a system for delivering and directing fluid to the desired location in the borehole, a system for reducing or controlling or managing debris in the laser beam path to the material surface, a means to control or manage the temperature of the optics, a means to control or manage the pressure surrounding the optics, and other components of the assembly, and monitoring and measuring equipment and apparatus, as well as, other types of downhole equipment that are used in conventional mechanical drilling operations.

The LBHA and optics, in at least one aspect, can provide that a beam spot pattern and continuous beam shape may be formed by a refractive, reflective, diffractive or transmissive grating optical element. Refractive, reflective, diffractive or transmissive grating optical elements may be made, but are not limited to being made, of fused silica, quartz, ZnSe, Si, GaAs, YAG, polished metal, sapphire, and/or diamond. These may be, but are not limited to being, optically coated with the said materials to reduce or enhance the reflectivity.

In accordance with one or more aspects, one or more refractive lenses, diffractive elements, transmissive gratings, and/or reflective lenses may be added to focus, scan, and/or change the beam spot pattern from the beam spots emitting from the fiber optics that are positioned in a pattern. One or more refractive lenses, diffractive elements, transmissive gratings, and/or reflective lenses may be added to focus, scan, and/or change the one or more continuous beam shapes from the light emitted from the beam shaping optics. A collimator may be positioned after the beam spot shaper lens in the transversing optical path plane. The collimator may be an aspheric lens, spherical lens system composed of a convex lens, thick convex lens, negative meniscus, and bi-convex lens, gradient refractive lens with an aspheric profile and achromatic doublets. The collimator may be made of the said materials, fused silica, ZnSe, SF glass, YAG, or a related material. The collimator may be coated to reduce or enhance reflectivity or transmission. Said optical elements may be cooled by a purging liquid or gas.

In some aspects, the fiber optics and said one or more optical elements lenses and beam shaping optics may be encased in a protective optical head made of, for example, the materials steel, chrome-moly steel, steel cladded with hard-face materials such as an alloy of chromium-nickel-cobalt, titanium, tungsten carbide, diamond, sapphire, or other suitable materials known to those in the art which may have a transmissive window cut out to emit the light through the optical head.

In accordance with one or more aspects, a laser source may be coupled to a plurality of optical fiber bundles with the distal end of the fiber arranged to combine fibers together to form bundle pairs, such that the power density through one fiber bundle pair is within the removal zone, e.g., spallation or vaporization zone, and one or more beam spots illuminate the material, such as rock with the bundle pairs arranged in a pattern to remove or displace the rock formation.

In accordance with one or more aspects, the pattern of the bundle pairs may be spaced in such a way that the light from the fiber bundle pairs emerge in one or more beam spot patterns that comprise the geometry of a rectangular grid, a circle, a hexagon, a cross, a star, a bowtie, a triangle, multiple lines in an array, multiple lines spaced a distance apart non-linearly, an ellipse, two or more lines at an angle, or a related shape. The pattern of the bundle pairs may be spaced in such a way that the light from the fiber bundles emerge as one or more continuous beam shapes that comprise above geometries. A collimator may be positioned at a said distance in the same plane below the distal end of the fiber bundle pairs. One or more beam shaping optics may be positioned at a distance in the same plane below the distal end of the fiber bundle pairs. An optical element such as a non-axis-symmetric lens may be positioned at a said distance in the same plane below the distal end of the fiber bundle pairs. Said optical elements may be positioned at an angle to the rock formation and rotated on an axis. The optical fibers may be single-mode and/or multimode. The optical fiber bundles may be composed of single-mode and/or multimode fibers. It is readily understood in the art that the terms lens and optic(al) elements, as used herein is used in its broadest terms and thus may also refer to any optical elements with power, such as reflective, transmissive or refractive elements. In some aspects, the optical fibers may be entirely constructed of glass, hollow core photonic crystals, and/or solid core photonic crystals. The optical fibers may be jacketed with materials such as, polyimide, polyamide, acrylate, carbon polyamide, or carbon/dual acrylate. Light may be sourced from a diode laser, disk laser, chemical laser, fiber laser, or fiber optic source is focused by one or more positive refractive lenses.

In at least one aspect, the positive refractive lens types may include, a non-axis-symmetric optic such as a plano-convex lens, a biconvex lens, a positive meniscus lens, or a gradient refractive index lens with a plano-convex gradient profile, a biconvex gradient profile, or positive meniscus gradient profile to focus one or more beams spots to the rock formation. A positive refractive lens may be comprised of the materials, fused silica, sapphire, ZnSe, YAG, or diamond. Said refractive lens optical elements can be steered in the light propagating plane to increase/decrease the focal length. The light output from the fiber optic source may originate from a plurality of one or more optical fiber bundle pairs forming a beam shape or beam spot pattern and propagating the light to the one or more positive refractive lenses.

In some aspects, the refractive positive lens may be a microlens. The microlens can be steered in the light propagating plane to increase/decrease the focal length as well as perpendicular to the light propagating plane to translate the beam. The microlens may receive incident light to focus to multiple foci from one or more optical fibers, optical fiber bundle pairs, fiber lasers, diode lasers; and receive and send light from one or more collimators, positive refractive lenses, negative refractive lenses, one or more mirrors, diffractive and reflective optical beam expanders, and prisms. In at least one aspect, the positive refractive lens may focus the multiple beam spots to multiple foci, to remove or displace the rock formation.

The apparatus and methods of the present invention may be used with drilling rigs and equipment such as in exploration and field development activities. Thus, they may be used with, by way of example and without limitation, land based rigs, mobile land based rigs, fixed tower rigs, barge rigs, drill ships, jack-up platforms, and semi-submersible rigs. They may be used in operations for advancing the well bore, finishing the well bore and workover activities. They may further be used in any application where the delivery of the laser beam to a location, apparatus or component that is located in a well bore and more preferably deep in the well bore may be beneficial or useful.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and with existing equipment or activities which may be modified, in-part, based on the teachings of this specification. Further, the various embodiments set forth in this specification may be used with each other in different and various combinations. Thus, for example, the configurations provided in the various embodiments of this specification may be used with each other; and the scope of protection afforded the present inventions should not be limited to a particular embodiment, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

What is claimed:

1. A high power optical slip ring comprising:
a. a base defining a cavity;
b. an input fiber that is fixed and non-rotating with respect to the base;
wherein the laser beam is launched from the input fiber into free space within the cavity, the input fiber in optical communication with a high power laser;
c. a pair of lenses that are fixe and non-rotating with respect to the base and the input fiber; and,
d. a output fiber that is rotatable with respect to input fiber;
e. wherein the optical slip ring is configured to transmit a high power laser beam from a non-rotating optical fiber to a rotating output optical fiber.

2. The optical slip ring of claim 1, wherein the input fiber has a core of about 200 μm.

3. The optical slip ring of claim 2, wherein the output fiber has a core of about 400 μm.

4. The optical slip ring of claim 1, wherein the output fiber has a core of about 200 to about 700 μm.

5. The optical slip ring of claim 1, wherein the output fiber has a core of about 600 sum.

6. The optical slip ring of claims 1, 2, 3, 4, and 5, wherein the coupling efficiency is at least 95% or greater.

7. The optical slip ring of claims 1, 2, 3, 4, and 5, wherein the coupling efficiency is at least 98% or greater.

8. The optical slip ring of claims 1, 2, 3, 4, and 5, wherein the coupling efficiency is at least 99.5% or greater.

9. The optical slip ring of claims 1, 2, 3, 4, and 5, wherein the coupling efficiency is at least 99.99% or greater.

10. The optical slip ring of claims 1, 2, 3, 4, and 5, wherein the NA of the input fiber is from about 0.18 to about 0.22.

11. The optical slip ring of claims 1, 2, 3, 4, and 5, wherein the NA of the input fiber is from about 0.18 to about 0.20.

12. The optical slip ring of claims 1, 2, 3, 4, and 5, wherein the NA of the output fiber is from about 0.19 to about 0.24.

13. The optical slip ring of claims 1, 2, 3, 4, and 5, wherein the NA of the output fiber is from about 0.21 to about 0.24.

14. The optical slip ring of claims 1, 2, 3, 4, and 5, wherein the NA of the output fiber is from about 0.20 to about 0.24 and the NA of the input fiber is about 0.18 to 0.20.

15. The optical slip ring of claims 1, 2, 3, 4, and 5, wherein the laser has a power of 60 kW or more.

16. The optical slip ring of claims 1, 2, 3, 4, and 5, wherein the laser has a power of 40 kW to 80 Kw, and wherein the NA of the output fiber is from about 0.20 to about 0.24 and the NA of the input fiber is about 0.18 to 0.20.

17. The optical slip ring of claims 1, 2, 3, 4, and 5, wherein the laser has a power of 40 kW to 80 Kw, wherein the NA of the output fiber is from about 0.20 to about 0.24 and the NA of the input fiber is about 0.18 to 0.20 and wherein the coupling efficiency is greater than 99.99%.

18. The optical slip ring of claims 1, 2, 3, 4, and 5, wherein the laser has a power of 40 kW to 80 Kw, wherein the NA of the output fiber is from about 0.20 to about 0.24 and the NA of the input fiber is about 0.18 to 0.20 and wherein the coupling efficiency is 100%.

19. A high power laser system for advancing a borehole, the system comprising:
a. a means for generating a plurality of high power laser beams, the means comprising a plurality of solid state laser sources, each solid state laser source having a wavelength from about 400 nm to about 1,500 nm, the solid state laser sources selected from the group consisting of fiber lasers, semiconductor lasers and diode lasers, whereby the solid state laser sources are configured to deliver a plurality of laser beams, wherein each laser beam has a power of from about 2 kW to about 30 kW, with a total power of the plurality of beams being 60 kW or more;
b. the plurality of solid state laser sources in optical communication with an optical slip ring, the optical slip ring comprising an input fiber in optical communication with the sold state laser sources, a pair of lenses that receive and re-focus the laser beam on a rotatable output fiber; the rotatable output fiber in optical communication with a laser kerfing bottom hole assembly;
c. the laser kerfing bottom hole assembly, comprising a pressure window having a gas side and a flowing fluid side;
d. the laser kerfing bottom hole assembly defining a laser beam pattern and mechanical removal pattern on the bottom surface of the borehole.

20. The system of claim 19, wherein the laser pattern and the mechanical cutter pattern do not overlap.

21. The system of claim 19, wherein the laser pattern and the mechanical cutter pattern overlap.

22. The systems of claims 19, 20, and 21, wherein the system is configured to generate from about 5 to about 100 laser beams.

23. The system of claims 19, 20, and 21, wherein the system is configured to generate from about 10 to about 20 laser beams.

24. The system of claims 19, 20, and 21, wherein the coupling efficiency is greater than 99.9%.

25. A method of transmitting a high power laser beam across a rotating junction, the method comprising:
a. transmitting a high power laser beam, having a power of at least 40 kW through an input fiber having an input connector, the input fiber in optical communication with an optical slip ring;
b. launching the laser beam from input connector to a pair of lenses; the lenses directing and focusing the laser beam on a rotating output connector having a rotating output fiber; and,
c. the laser beam entering the rotating core of the output fiber with 100% coupling efficiency.
